(19) United States
(12) Patent Application Publication
(10) Pub. No.: US 2009/0292735 A1
(43) Pub. Date: Nov. 26, 2009

(54) DECLUTTERING A COMPUTING SYSTEM

(75) Inventor: Sandeep Sahasrabudhe, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/125,900

(22) Filed: May 22, 2008

(51) Int. Cl. G06F 17/30

(52) U.S. Cl. 707/200; 707/E17.009

(57) ABSTRACT

Technologies are described herein for decluttering a computing system by removing a visual display or performance impact caused by pre-installed software components. Through the decluttering process, icons and other visual indications of pre-installed software are removed, thereby eliminating visual clutter. The decluttering process also prevents the automatic execution of pre-installed software, thereby eliminating the performance impact caused by these programs. Because the decluttering process does not uninstall the pre-installed software, the process can be reversed, thereby returning the pre-installed software to its original state.

### BACKGROUND

Original equipment manufacturers (“OEMs”) often sell personal computers that are cluttered with software that was not explicitly ordered by the purchaser. For instance, new computers are often sold with a large number of pre-installed trial programs, some of which may include significant limitations on their functionality unless a full version is purchased. Other times fully capable versions of programs are installed on the computer even though the purchaser did not consciously request them.

In order to make the purchaser aware of the presence of these pre-installed programs and to encourage the use of these programs, OEMs often place icons corresponding to shortcuts for launching the programs on a graphical user interface (“GUI”) desktop or in other locations visible within a GUI provided by a computer. In many cases, a newly purchased computer will include many icons on the desktop, which can be confusing to a new user. Additionally, the OEM may configure these programs for automatic execution when the computer starts up and may install services or other components that consume the memory, mass storage, and processing resources of the computer, thereby degrading performance.

While functionality does exist in new computers for uninstalling undesirable OEM-installed software, it can be difficult for many users to know for certain whether a particular software package can be uninstalled without an adverse impact on other programs. Moreover, uninstalling a large number of OEM-installed software components can be a time consuming process. As a result, most users simply use their new computer as it is provided by the OEM, despite the significant visual clutter and performance impact caused by the unwanted OEM-installed software.

It is with respect to these considerations and others that the disclosure made herein is presented.

### SUMMARY

Technologies are described herein for decluttering a computer system. Decluttering refers generally to the process of removing a visual indication or performance impact of a pre-installed software component, like unwanted OEM-installed software. Through the decluttering process described herein, icons and other visual indications of pre-installed software are removed, thereby eliminating the visual clutter so common on newly purchased computers. Moreover, the decluttering process described herein also prevents the automatic execution of pre-installed software, thereby eliminating the performance impact caused by these programs. The decluttering process presented herein does not, however, uninstall the pre-installed software. As a result, the decluttering process can be reversed, thereby returning the pre-installed software to its original state.

According to one aspect presented herein, several different types of software clutter installed on a computer are identified. Software clutter refers to software components pre-installed or configured on a computer that generate an undesirable visual display or cause an undesirable performance impact. For instance, types of software clutter may include, but are not limited to, desktop icons, programs or services launched automatically at startup or at another time, World Wide Web (“Web”) browser plug-ins or settings, client application plug-ins, and modifications to default visual settings or other types of settings maintained by an operating system such as default desktop wallpaper, file associations, or the contents of menus. Each of these types of software clutter is commonly pre-installed on new computers.

Once the software clutter on a computer has been identified, the installation of the software clutter is modified to eliminate a visual display caused by the software clutter or to prevent the computer from executing the software clutter. In order to accomplish this, the software clutter may be moved from one location in a file system maintained by the computer to another location in the file system. For instance, icons or other types of software clutter stored in a directory used for storing items that are displayed on a GUI desktop may be moved to another directory that is not used for storing displayed items. Similarly, programs or shortcuts stored in a directory for storing items that are executed upon the startup of the computer may be moved to another directory for storing items that are not automatically executed. Keys corresponding to software clutter stored within a registry maintained by the computer may also be moved to thereby eliminate the visual display caused by or execution of the software clutter. Because the software clutter is moved and not deleted, the decluttering process can be reversed at any time, thereby returning the software clutter to its original state if desired.

According to another aspect, a decluttering program is provided for performing the decluttering process presented herein. The decluttering program includes a decluttering engine and decluttering modules. The decluttering engine manages the decluttering process. Each of the decluttering modules is configured to handle the decluttering of one type of software clutter installed on the computer. The decluttering engine calls the decluttering modules as necessary to declutter the computer.

According to another aspect, the decluttering modules utilize a decluttering database during the decluttering process. The decluttering database includes links to each of the decluttering modules, a while list, and a black list. The white list includes data identifying any software components that should not be modified by the decluttering modules. The black list includes data identifying software clutter that may be modified by the decluttering modules even if identified in the white list. Individual white lists and black lists may be utilized for each of the decluttering modules. Moreover, the decluttering engine, decluttering modules, and the decluttering database may be periodically updated from a server computer.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computer architecture diagram showing an illustrative computer hardware and software architecture for a computing system capable of implementing aspects of the embodiments presented herein;

FIG. 2 is a software architecture diagram showing aspects of a decluttering program and an update server provided in embodiments described herein;

FIG. 3 is a database architecture diagram showing aspects of a decluttering database provided in one embodiment presented herein;

FIG. 4 is a software architecture diagram showing aspects of a file system and the operation of the decluttering program presented herein in embodiments; and

FIGS. 5-6 are flow diagrams illustrating aspects of one illustrative process for decluttering a computing system presented herein.

### DETAILED DESCRIPTION

The following detailed description is directed to technologies for decluttering a computing system. Through the use of the technologies and concepts presented herein, the visual display and performance impact of software clutter, like pre-installed but undesirable software components, can be removed from a computer in an automated fashion. While the subject matter described herein is presented in the general context of program modules that execute in conjunction with the execution of an operating system and application programs on a computer system, those skilled in the art will recognize that other implementations may be performed in combination with other types of program modules.

Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for decluttering a computing system will be described.

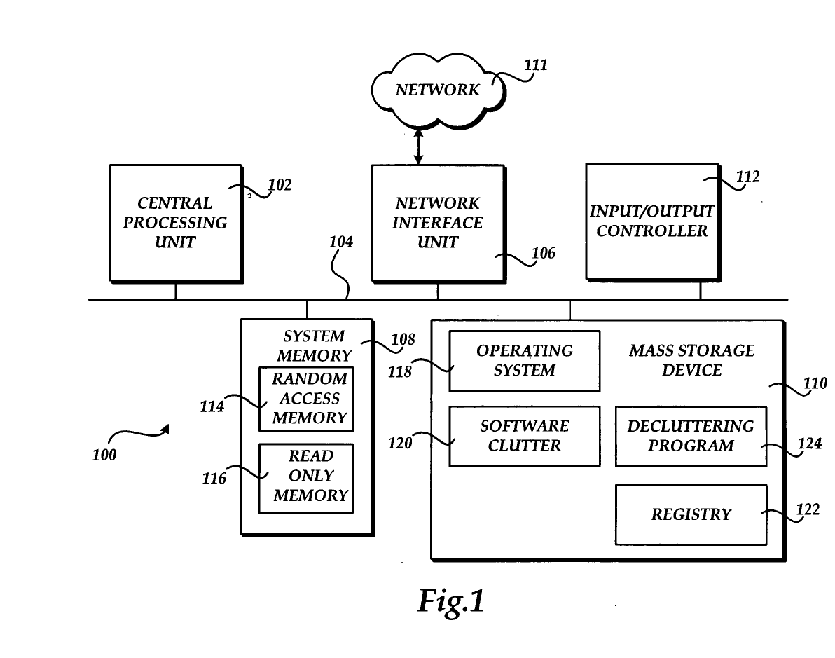

FIG. 1 shows an illustrative computer architecture for a computer 100 capable of executing the software components described herein for decluttering a computing system. The computer architecture shown in FIG. 1 illustrates a conventional desktop, laptop, or server computer and may be utilized to execute any aspects of the software components presented herein. The computer architecture shown in FIG. 1 includes a central processing unit 102 (“CPU”), a system memory 108, including a random access memory 114 (“RAM”) and a read-only memory (“ROM”) 116, and a system bus 104 that couples the memory to the CPU 102. A basic input/output system containing the basic routines that help to transfer information between elements within the computer 100, such as during startup, is stored in the ROM 116. The computer 100 further includes a mass storage device 110 for storing an operating system 118, application programs, and other program modules and data, which are described in greater detail herein.

The mass storage device 110 is connected to the CPU 102 through a mass storage controller (not shown) connected to the bus 104. The mass storage device 110 and its associated computer-readable media provide non-volatile storage for the computer 100. Although the description of computer-readable media contained herein refers to a mass storage device, such as a hard disk or CD-ROM drive, it should be appreciated by those skilled in the art that computer-readable media can be any available computer storage media that can be accessed by the computer 100.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 100.

According to various embodiments, the computer 100 may operate in a networked environment using logical connections to remote computers through a network such as the network 111. The computer 100 may connect to the network 111 through a network interface unit 106 connected to the bus 104. It should be appreciated that the network interface unit 106 may also be utilized to connect to other types of networks and remote computer systems. The computer 100 may also include an input/output controller 112 for receiving and processing input from a number of other devices, including a keyboard, mouse, or electronic stylus (not shown in FIG. 1). Similarly, an input/output controller may provide output to a display screen, a printer, or other type of output device (also not shown in FIG. 1).

As mentioned briefly above, a number of program modules and data files may be stored on the mass storage device 110 of the computer 100, including an operating system 118 suitable for controlling the operation of a networked desktop, laptop, or server computer. In order to store the program modules and data files, the computer 100 organizes the contents of the mass storage device 110 using a file system. As known in the art, a file system is a method for organizing files and directories on a storage device. Through the use of the file system, the physical location of the directories and files stored in the mass storage device 110 are maintained. The file system is typically maintained by the operating system 118.

Certain pre-defined directories stored within the file system of the mass storage device 110 may be utilized to store items that are displayed by the computer 100 on a display screen. For instance, many operating systems are configured to display the contents of a pre-defined “desktop” directory on a GUI desktop. Icons, programs, documents, and other software components stored within the desktop directory will be displayed by the operating system 118. The operating system 118 may also display items stored in other pre-defined directories in other locations. For instance, the WINDOWS family of operating systems from MICROSOFT may display items in certain pre-defined directories in a “quick launch toolbar”, a “start menu”, and in other locations within the GUI. Other operating systems may also display items in a GUI that are stored in pre-defined directories within the file system.

The operating system 118 may also be configured to execute items stored within certain pre-defined directories within the file system of the mass storage device 110 when the computer 100 is started. For instance, the operating system 118 may execute programs or services identified in a “startup items” directory each time the operating system 118 is booted on the computer 100. Programs and services may also be executed by the operating system 118 at startup time by identifying them in pre-defined location in a registry 122. Additional details regarding the registry 122 are provided below.

According to embodiments, the operating system 118 is also configured to maintain the registry 122, mentioned briefly above. The registry 122 is utilized by some operating systems, such as the WINDOWS family of operating systems from MICROSOFT CORPORATION, for storing settings and options. For instance, the registry 122 may be utilized to store “keys” that identify configuration information and settings for the hardware of the computer 100, the operating system 118, non-operating system software, and users of the computer 100. The registry 122 may also be utilized to specify programs or services that should be executed by the operation system 118 at startup time, specify default file associations, specify plug-ins for use with applications executing on the computer 100, and to specify the default graphical image (“wallpaper”) to be displayed on a GUI desktop provided by the operating system 118. Keys in the registry may also be utilized to specify other settings for the operating system 118 and application programs stored on the mass storage device 110.

According to embodiments presented herein, software clutter 120 is also stored on the mass storage device 110. Software clutter refers to software components pre-installed or configured on the computer 100 that generate an undesirable visual display or cause an undesirable performance impact. For instance, types of software clutter may include, but are not limited to, desktop icons, programs or services launched automatically at startup or at another time, Web browser plug-ins or settings, client application plug-ins or settings, and modifications to default visual settings or other types of settings maintained by the operating system 118 such as the default desktop wallpaper, file associations, or the contents of menus.

Each of the types of software clutter 120 identified above is commonly pre-installed and configured on new computers by OEMs. For instance, OEMs will often place programs or shortcuts to programs within the desktop directory maintained by the operating system 118. As a result, the computer 100 will display icons corresponding to the programs or shortcuts on the GUI desktop, frequently causing an unattractive and cluttered visual appearance. OEMs also commonly place programs, services, and shortcuts in the startup items folder utilized by the operating system 118. As a result, the referenced programs or services are executed at the time the computer 100 is started, thereby decreasing the performance of the computer 100. Similarly, OEMs often place keys in the registry 122 of the computer 100 that cause programs or services to be executed automatically, that cause application plug-ins to be utilized, and that modify default visual settings or other types of settings maintained by the operating system 118.

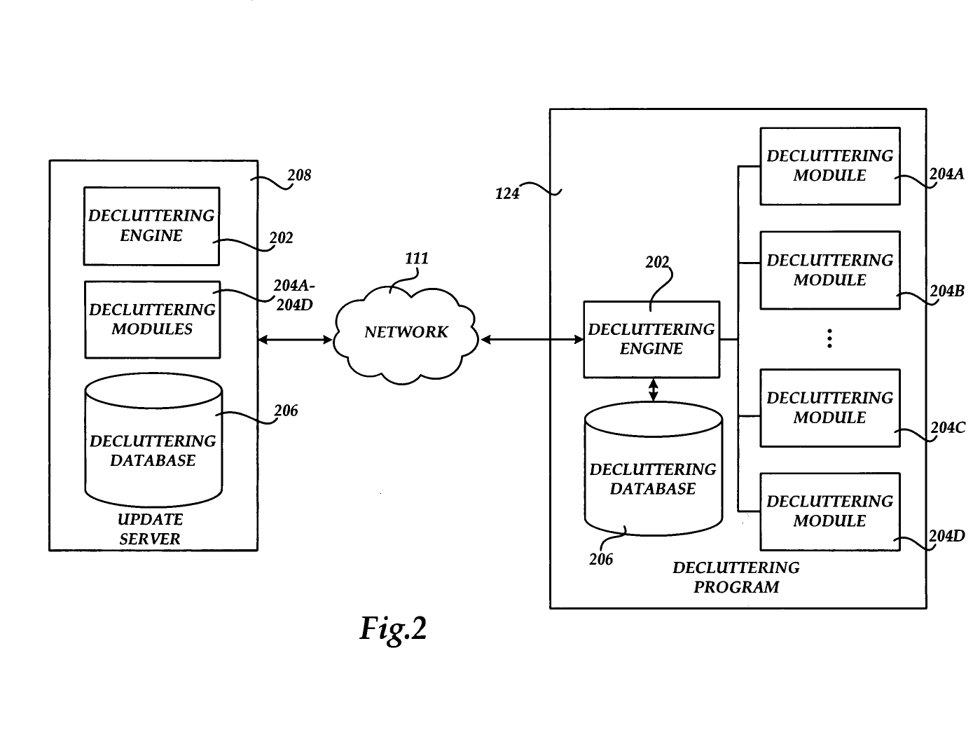

In order to eliminate the visual clutter and performance impact caused by the software clutter 120, the embodiments presented herein provide a decluttering program 124 that is capable of decluttering the computer 100. As used herein, the term decluttering refers to the process of removing a visual indication or performance impact of the software clutter 120. Through the decluttering process described herein, icons and other visual indications caused by the software clutter 120 are removed. Moreover, the decluttering process described herein also prevents the automatic execution of the software clutter 120, thereby eliminating the performance impact caused thereby. The decluttering process presented herein does not, however, uninstall the software clutter 120. As a result, the decluttering process can be reversed, thereby returning the modified software clutter 120 to its original state. Additional details regarding the structure and operation of the decluttering program 124 in one embodiment are presented below with respect to FIGS. 2-6.

Turning now to FIG. 2, additional details regarding the decluttering program 124 will be described. As shown in FIG. 2, the decluttering program 124 includes a decluttering engine 202 and several decluttering modules 204A-204D. The decluttering engine 202 coordinates the decluttering process described herein. In particular, the decluttering engine 202 is configured in one embodiment to communicate with an update server 208 over the network 111. Through the communication with the update server 208, the decluttering engine 202 can download updated versions of itself, the decluttering modules 204A-204D, and the decluttering database 206. If no connection with the update server 208 can be established, the decluttering engine 202 is configured to utilize the most recently downloaded decluttering modules 204A-204D and decluttering database 206. Through communication with the update server 208, the decluttering engine 202 ensures that the most recent versions of the decluttering database 206 and the decluttering modules 204A-204D will be utilized during the decluttering process described herein.

As will be described in greater detail below, the decluttering modules 204A-204D are each configured to address one type of software clutter 120. For instance, an individual decluttering module 204A may be configured to clean up unwanted desktop items, remove programs or services launched at the startup of the computer 100, remove application plug-ins, reset file associations, eliminate clutter in a quick launch toolbar or a start menu, or to reset the default wallpaper utilized by the operating system 118 to its default value. In other embodiments, a single decluttering module is utilized to address each of the various types of software clutter 120 present on the computer 100.

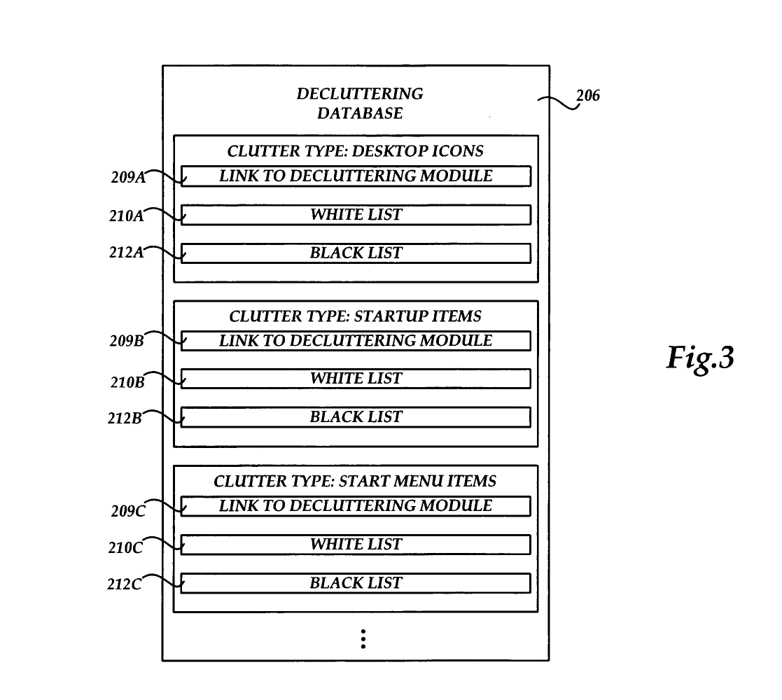

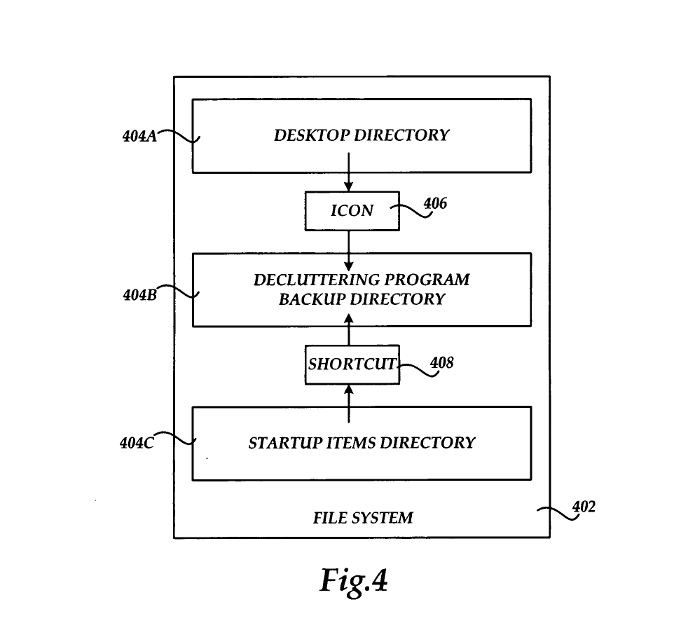

In order to identify the software clutter 120 that should be addressed, the decluttering modules 204A-204D utilize the contents of the decluttering database 206. As will be discussed in greater detail with respect to FIG. 3, the decluttering database 206 provides data that assists the decluttering engine 202 in locating the most recent versions of the decluttering modules 204A-204D. The decluttering database 206 also provides data utilized by the decluttering modules 204A-204D to assist in the identification of the software clutter 120. Details regarding the contents and structure of the decluttering database 206 in one implementation are provided below with respect to FIG. 3. Additional details regarding the operation of the decluttering engine 202 and the decluttering modules 204A-204D are provided below with respect to FIGS. 4-6.

Referring now to FIG. 3, additional details will be provided regarding the structure of the decluttering database 206 in one embodiment provided herein. As illustrated in FIG. 3, the decluttering database includes entries for each type of software clutter 120 that may be present on the computer 100. For instance, entries may be provided in the decluttering database 206 corresponding to desktop icons, startup items, start menu items, and others. For each type of software clutter 120 identified within the decluttering database 206, several items of information are present. In particular, a link 209 is provided to the most recent version of the decluttering module 204 for addressing the specific type of software clutter 120. For instance, in the example shown in FIG. 3, the link 209A corresponds to one of the decluttering modules 204A-204D for addressing unwanted desktop icons.

In one embodiment, each entry in the decluttering database 206 also includes a white list 210 and black list 212 for the particular type of software clutter 120. In the example shown in FIG. 3, the white list 210A and the black list 212A are specified for unwanted desktop icons.

According to embodiments presented herein, the white list 210 includes data identifying any software components that should not be modified by the decluttering modules 204A-204D. For instance, with respect to desktop icons, the white list 210A may be utilized to specify icons that should not be moved from the GUI desktop by the decluttering modules 204A-204D. The black list 212 is utilized to override the contents of the white list 210. In particular, the black list 212 includes data identifying software clutter 120 that may be modified by the decluttering modules even if identified in the white list. For example, in the illustrative decluttering database 206 shown in FIG. 3, a black list 212B may be specified that identifies startup items that should be moved from a startup items folder even if the items are identified within the white list 210B. Similarly, the black list 212C may specify start menu items that should be removed from the start menu provided by the operating system 118 even where the items are specified within the white list 210C.

It should be appreciated that, according to embodiments, the decluttering database 206 includes additional information not illustrated in FIG. 3. Additional details regarding the use of the decluttering database 206 by the decluttering modules 204A-204D will be provided below with respect to FIGS. 4-6. It should also be appreciated that, although a single decluttering database 206 is illustrated in FIG. 2, individual decluttering databases may be utilized by the decluttering modules 204A-204D. In this manner, a separate decluttering database 206 may be maintained for each type of software clutter 120 that is to be addressed by the decluttering modules 204A-204D.

Turning now to FIG. 4, additional details will be provided regarding the operation of the decluttering modules 204A-204D. In particular, FIG. 4 illustrates several actions that the decluttering modules 204A-204D may take in order to remove the visual indications and performance impact caused by the software clutter 120. As discussed above, the operating system 118 may utilize a desktop directory 404A to store programs, icons, documents, and other objects that are displayed on a GUI desktop. When one of the decluttering modules 204A-204D identifies software clutter 120 that is stored in the desktop directory 404A, the appropriate decluttering module 204 will move the icon 406 to a backup directory 404B maintained by the decluttering module 204. In this manner, the icon 406 will no longer be displayed on the GUI desktop by the operating system 118.

It should be appreciated that the decluttering module 204 does not uninstall, delete, or otherwise modify the icon 406. Rather, the icon 406 is simply moved from the desktop directory 404A to the backup directory 404B. Because the icon 406 is not uninstalled or otherwise modified, the decluttering engine 202 can later return the icon 406 from the backup directory 404B to its original location in the desktop directory 404A, thereby reversing the effects of the decluttering process described herein. It should be appreciated that other types of programs, documents, and objects may also be moved from the desktop directory 404A to the backup directory 404B in a similar manner.

As also discussed above, items may be placed in a startup items directory 404C. These items are automatically executed by the operating system 118 at startup time. For instance, a shortcut 408 may be placed in the startup items directory 404C corresponding to a trialware program. In order to prevent the program from executing, one of the decluttering modules 204A-204D will move the shortcut 408 from the startup items directory 404C to the decluttering program backup directory 404B. The next time the computer 100 is restarted, the program referenced by the shortcut 408 will not be executed. As with the icon 406, the shortcut 408 is not uninstalled, deleted, or otherwise modified. As a result, the decluttering engine 202 can easily undo the decluttering process by moving the shortcut 408 from the backup directory 404B to the startup items directory 404C. In this regard, each of the decluttering modules 204A-204D may expose an application programming interface (“API”) that returns a list of steps taken during the decluttering process. An API may also be provided which, when called, will cause the decluttering module 204A-204D to revert a list of previously performed steps.

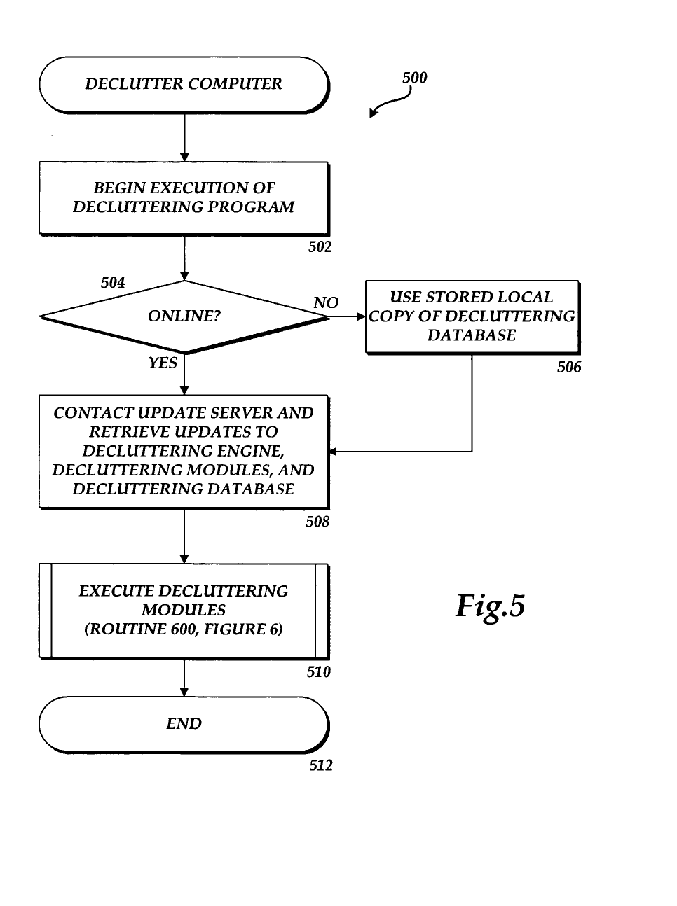

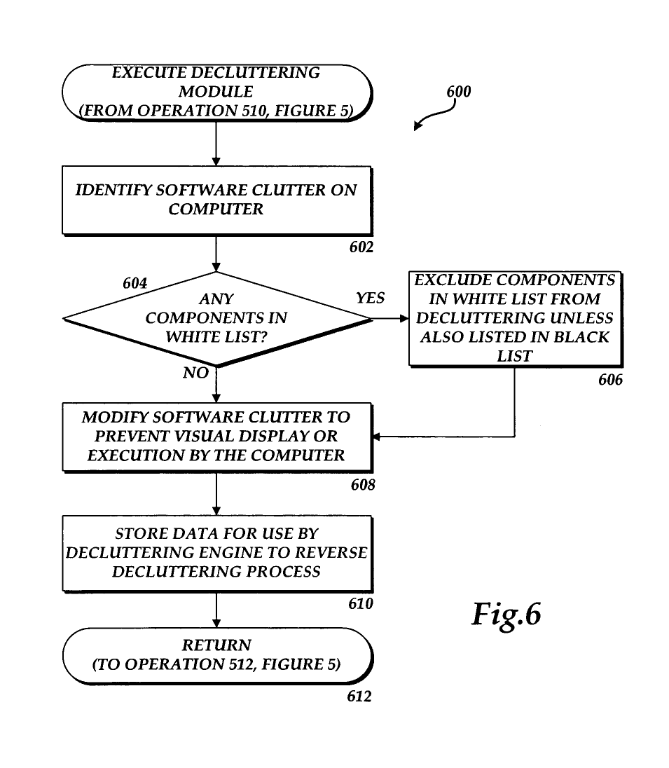

As also discussed above, the registry 122 may also be modified by OEMs to cause programs to be automatically executed, to override default settings specified by the operating system 118, and to perform other types of changes. In order to reverse the effects of this type software clutter 120, the decluttering modules 204A-204D can move keys from predefined locations within the registry 122 to a backup location. In this manner, the keys specified in the registry 122 by the software clutter 120 will no longer be utilized by the operating system 118. As with the icon 406 and shortcut 408 described above, the keys moved in the registry 122 are not uninstalled, deleted, or otherwise modified. In this way, changes made to the registry 122 to remove the software clutter 120 can be easily reversed in the manner described above. Additional detail regarding the operation of the decluttering engine 202 and the decluttering modules 204A-204D are provided below with respect to FIGS. 5-6.

Referring now to FIG. 5, additional details will be provided regarding the embodiments presented herein for decluttering the computer 100. In particular, FIG. 5 is a flow diagram showing a routine 500 that illustrates aspects of the operation of decluttering program 124. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 500 begins at operation 502, where the decluttering program 124 is executed. When execution begins, the decluttering engine 202 checks to determine whether an online connection can be established with the update server 208. Accordingly, a determination is made at operation 504, as to whether the computer 100 is online and connected to the update server 208. If an online connection cannot be established, the routine 500 proceeds from operation 504 to operation 506, where the decluttering engine 202 utilizes the stored local copy of the decluttering database 206 and previously obtained versions of the decluttering modules 204A-204D.

If, at operation 504, the decluttering engine 202 determines that an online connection can be established to the update server 208, the routine 500 proceeds to operation 508. At operation 508, the decluttering engine communicates with the update server 208 via the network 111 to retrieve updates to the decluttering engine 202, the decluttering modules 204A-204D, and the decluttering database 206. In this manner, the decluttering engine 202 ensures that updated components are obtained prior to beginning the decluttering process.

From operation 508, the routine 500 proceeds to operation 510 where each of the decluttering modules 204A-204D are executed. As discussed above, each of the decluttering modules 204A-204D is configured in one embodiment for identifying and modifying one particular type of software clutter 120. In addition, each of the decluttering modules 204A-204D is configured for reversing the decluttering process for the respective type of software clutter 120. Additional details regarding the execution of the decluttering modules 204A-204D are provided below with respect to FIG. 6. Once each the decluttering modules 204A-204D has completed its execution, the routine 500 proceeds from operation 510 to operation 512, where it ends.

Referring now to FIG. 6, details will be provided regarding the execution of the decluttering modules 204A-204D. In particular, the routine 600 illustrates the operation of one of the decluttering modules 204A-204D. It should be appreciated that similar processing is performed by each of the decluttering modules 204A-204D.

The routine 600 begins at operation 602, where the decluttering module 204 identifies one type of software clutter 120 present on the computer 100. As discussed above, individual decluttering modules 204A-204D may be provided for identifying and removing desktop icons, programs and services launched at startup, application plug-ins and settings, file associations, quick launch toolbar and start menu items, and non-default desktop wallpaper. Once the particular type of software clutter 120 has been identified, the routine 600 proceeds from operation 602 to operation 604.

At operation 604, the decluttering module determines whether any components within the identified software clutter 120 are identified in the white list 210 corresponding to the particular type of software clutter. If any components are identified in the white list 210, the routine 600 proceeds to operation 606 where the components identified in the white list 210 are excluded from the decluttering process unless the components are also listed in the black list 212 for the particular type of software clutter 120. If, however, at operation 604, it is determined that no components within the identified software clutter 120 are identified in the white list 210, the routine 600 proceeds to operation 608.

At operation 608, the decluttering module modifies the identified software clutter 120 to prevent its visual display or execution by the computer 100. As discussed above, this processing may include moving the software clutter 120 from a first directory to a second directory on the file system maintained by the mass storage device 110. Movement of the software clutter 120 may be done to ensure that the software clutter 120 is not displayed by the operation system 118 or executed by the operation system 118. Additionally, the decluttering module may move keys within the registry 122 corresponding to the software clutter 120 to prevent programs or services from being automatically executed by the operating system 118. It should be appreciated that in other embodiments, the decluttering modules 204A-204D may take other types of actions to prevent a visual display of the software clutter 120 or execution of the software clutter 120 by the operation system 118.

From operation 608, the routine 600 proceeds to operation 610, where the particular decluttering module stores data for use by the decluttering engine 202 in reversing the decluttering processes 610. As discussed above, the decluttering modules 204A-204D may expose APIs for accessing this data and for using this data to reverse the decluttering process. From operation 610, the routine 600 proceeds to operation 612, where it returns to operation 512, described above.

Based on the foregoing, it should be appreciated that technologies for decluttering a computing system are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for decluttering a computer, the method comprising:
identifying a plurality of types of software clutter installed on the computer; and
in response to identifying the plurality of types of software clutter installed on the computer, modifying the software clutter installed on the computer to thereby cause the software clutter to not be displayed by the computer or to thereby cause the software clutter to not be executed by the computer.

2. The method of claim 1, wherein the computer is configured to maintain a file system including a first location and a second location, wherein items stored in the first location are displayed by the computer and items stored in the second location are not displayed by the computer, and wherein modifying the software clutter installed on the computer to thereby cause the software clutter to not be displayed by the computer comprises moving the software clutter from the first location to the second location.

3. The method of claim 1, wherein the computer is configured to maintain a file system including a first location and a second location, wherein items stored in the first location are executed by the computer and items stored in the second location are not executed by the computer, and wherein modifying the software clutter installed on the computer to thereby cause the software clutter to not be executed by the computer comprises moving the software clutter from the first location to the second location.

4. The method of claim 1, wherein the computer is configured to maintain a registry comprising one or more locations storing one or more keys, and wherein modifying the software clutter installed on the computer to thereby cause the software clutter to not be executed by the computer comprises moving a key corresponding to the software clutter from a first location in the registry to a second location in the registry.

5. The method of claim 1, wherein identifying a plurality of types of software clutter installed on the computer comprises executing a decluttering program on the computer, the decluttering program comprising a decluttering engine and a plurality of decluttering modules, each of the decluttering modules configured to handle the modification of one of the plurality of types of software clutter installed on the computer.

6. The method of claim 5, wherein the decluttering engine is configured to maintain a decluttering database, the decluttering database comprising links to each of the decluttering modules, a white list, and a black list.

7. The method of claim 6, wherein the white list comprises data identifying software components that should not be modified by the decluttering modules.

8. The method of claim 7, wherein the black list comprises data identifying software clutter that may be modified by the decluttering modules even if identified in the white list.

9. The method of claim 8, wherein decluttering database comprises a white list and a black list for each of the decluttering modules.

10. The method of claim 8, wherein the decluttering program is configured to update the decluttering engine, the decluttering modules, and the decluttering database from a server computer.

11. A computer storage medium having computer executable instructions stored thereon which, when executed by a computer, cause the computer to execute a decluttering engine and a plurality of decluttering modules, each of the decluttering modules configured to identify a type of software clutter installed on the computer and to modify the identified software clutter to thereby cause the software clutter to not be displayed by the computer.

12. The computer storage medium of claim 11, wherein modifying the identified software clutter to thereby cause the software clutter to not be displayed by the computer comprises moving the software clutter from a first location to a second location on a file system maintained by the computer.

13. The computer storage medium of claim 11, wherein the decluttering engine is configured to maintain a decluttering database, the decluttering database comprising links to each of the decluttering modules, a white list, and a black list.

14. The computer storage medium of claim 13, wherein the white list comprises data identifying one or more software components that should not be modified by the decluttering modules.

15. The method of claim 14, wherein the black list comprises data identifying software clutter that may be modified by the decluttering modules even if identified in the white list.

16. The computer storage medium of claim 11, wherein each of the decluttering modules is further configured to modify the identified software clutter to thereby cause the software clutter to not be executed by the computer.

17. The computer storage medium of claim 16, wherein modifying the identified software clutter to thereby cause the software clutter to not be executed by the computer comprises moving the software clutter from a first location to a second location on a file system maintained by the computer.

18. The computer storage medium of claim 16, wherein modifying the identified software clutter to thereby cause the software clutter to not be executed by the computer comprises moving a key corresponding to the software clutter from a first location to a second location in a registry maintained by the computer.

19. The computer storage medium of claim 13, comprising further computer executable instructions which, when executed by the computer, cause the computer to update the decluttering engine, the decluttering modules, and the decluttering database from a server computer.

20. A method for decluttering a computer, the method comprising:
executing a decluttering engine on the computer, the decluttering engine configured to update itself, a plurality of decluttering modules, and a decluttering database from a server computer, and to cause the decluttering modules to be executed by the computer; and
executing the decluttering modules on the computer, each of the decluttering modules configured to utilize the contents of the decluttering database to identify a type of software clutter installed on the computer, to move the identified software clutter from a first directory to a second directory in a file system maintained by the computer to thereby cause the software clutter to not be displayed by the computer, to move the software clutter from a first directory to a second directory in a file system maintained by the computer to thereby cause the software clutter to not be executed by the computer, or to move a key corresponding to the software clutter from a first location to a second location in a registry maintained by the computer to thereby cause the software clutter to not be executed by the computer.
